(19) United States
(12) Patent Application Publication
(10) Pub. No.: US 2011/0005959 A1
(43) Pub. Date: Jan. 13, 2011

(54) PACKAGING FOR FOOD PRODUCTS, IN PARTICULAR DRIP-FEED

(76) Inventor: Alexander Josephus Maricus Van Puijenbroek, Den Bosch (NL)

Correspondence Address: SHERR & VAUGHN, PLLC, 620 HERNDON PARKWAY, SUITE 320, HERNDON, VA, 20170, US

(21) Appl. No.: 12/922,004

(22) PCT Filed: Mar. 10, 2009
(86) PCT No.: PCT/NL2009/050111

§ 371 Date: Sep. 29, 2010

(30) Foreign Application Priority Data
Mar. 10, 2008 (EP) 08152522.2

(51) Int. Cl. B65D 90/02; B32B 37/10

(52) U.S. Cl. 206/524.6; 156/242

(57) ABSTRACT

The invention relates to a packaging for drip-feed, comprising a deep-drawn thermoformed first part defining a product containing space having a rim with flange and a polymer film permanently-bonded to said flange for permanently covering and sealing said space, said polymer sealing film comprising an outlet near said rim, and said packaging further comprising an attachment eye in said flange opposite of said outlet, said packaging is shaped and said outlet is located near said rim to facilitate, when said packaging is suspended from said attachment eye, said packaging to empty under the force of gravity.

### BACKGROUND

The present invention relates to a packaging for food products, in particular liquid medical food products like drip-feed.

The demands on in particular drip-feed, sometimes also referred to as tube-feed, regarding hygiene are very high. Furthermore, these products have to be sealed and kept sterile. In the past, drip-feed was delivered in sterilized bottles. In use, these bottles were suspended upside-down, and a tube delivered its content to a patient. Nowadays, applicant provides drip-feed amongst others in a disposable packaging, referred to as the ‘Nutrison® Pack. This packaging is produced from various sheets of plastic foil to produce a pouch-like packaging, filled with drip-feed, and sterilized after filling and sealing. Heating the packaging put high demands on the packaging material. There is room for improvement of the packaging.

EP-1.210.960 relates to a needles valve for intravenous infusion. In its drawings, it shows a general schematic drawing of the general class of packaging for drip-feed of for intravenous application. As already mentioned, these packaging are widely used.

WO-A1-2006/068523 discloses a collapsible container for dispensable food in general, which container has concertina side walls which is produced using a thermoforming process. That container is permanently sealed at a flange with a sealing film which has, in a specific embodiment, a central mouth opening. The concertina side walls are for compressing the container for emptying it from yogurt or the like food products. This container has no means for suspending it. Furthermore, to cannot completely emptied using the force of gravity.

WO-A2-02/066337 discloses a packaging for granular food products which has a port with a sealing label or with a stopper in a deep-drawn part of the packaging. In case of use for drip-feed, the port as well as the closure for the port should be made in a packaging filled with a liquid contents. It is clear that this packaging in not suited for liquid contents, let alone drip-feed.

WO-A1-2004/005150 discloses a sealed pouch for “flowable products”, like ketchup, beauty aids and the like. The pouch should open when a flap of the pouch is raised. This makes this pouch unsuited for products like drip-feed.

WO-A1-97/17264 discloses a controlled atmosphere package for food. In this packaging, maintaining the proper balance of gases in a controlled atmosphere is important. The packaging has a sealing membrane and a protective lid with venting holes which leaves the sealing membrane free. This packaging does not seem to be suitable for liquid food products, let alone drip-feed.

FR-1.437.667 discloses a packaging for flower bulbs which has a deep-drawn part with a prismatic shape and with a circumferential flange with a hole in the flange for suspending the packaging. This hole, however, extends through a channel connecting with the inside of the packaging. The packaging is closed with a paper sheet. These features make the packaging unsuited for liquid products. U.S. Pat. No. 3,407,969 discloses a disposable packaging for fluid or pasty products. The packaging is substantially prismatic or wedge-shaped. The packaging seems to be made from plastic foil which is supported by cardboard. The packaging should be emptied using the force of gravity or by squeezing it.

DE-U-8215495 discloses a disposable packaging for food having a first part which is made from a deep-drawn foil. The packaging should be transparent in order for a customer to be able to inspect the contents, but also be suited to contain about 100-200 gr. of product. This packaging is clearly not suited for high-tech food products like drip-feed.

In particular when using the packaging for drip-feed, the requirements regarding the aseptic production environment, low failure rate in production and in filling, and protection against opening before use put high demands on the packaging.

### SUMMARY OF THE INVENTION

The invention aims to improve packaging for food, in particular for high-tech food products like drip-feed.

The invention further or alternatively aims at reducing costs of the current packaging.

The invention further or alternatively aims at providing improved aseptic, even sterile production and filling and secure use.

According to a first aspect of the invention this is realized with a packaging for drip-feed, comprising a deep-drawn thermoformed first part defining a product containing space having a rim with flange and a polymer film permanently-bonded to said flange for permanently covering and sealing said space, said polymer sealing film comprising an outlet near said rim, and said packaging further comprising an attachment eye in said flange opposite of said outlet, said packaging is shaped and said outlet is located near said rim to facilitate, when said packaging is suspended from said attachment eye, said packaging to empty under the force of gravity.

The invention furthermore provides a method for making a drip-feed packaging, comprising the steps of deep-drawing a first polymer film for making a deep-drawn thermoformed first part defining a drip-feed containing space, filling said product space with said drip-feed product, applying a second polymer film onto said first part, permanently sealing said second polymer film onto said first part.

Using deep-drawn parts allow a packaging to be produced which can be aseptic. It can be produced in a cheap way, at high speed, in particular as it allows fast filling. Furthermore, it allows a stronger material to be used.

Deep-drawn packaging as such is generally known, but was never used for delicate and demanding products and use like drip-feed. U.S. Pat. No. 6,415,939, for instance, which in fact involves reclosable dispenser packaging and in that respect shows many types of closings, in general discloses deep-drawn packaging. It does not refer to its use in delicate products like drip-feed, nor does it mention fast filling, nor other differences in comparison to the generally used type of packaging for these products up to now, or the specific requirements.

Another advantage of using deep-drawn packaging is that the technology involved as such is a very robust technology. For instance, when product is spilled on a rim or flange during filling, the sealing of the sealing film will still provide a liquid-tight seal.

It should be evident that although the shape and position of outlet are such that emptying under the influence of the force of gravity is facilitated, It may also be possible to empty the packaging using a pump. Positioning of the outlet near said rim, in particular bordering said rim, or adjoining said flange, will especially facilitate full emptying of the packaging. In particular, the attachment eye and the outlet are positioned in such a way that when the packaging is suspended from said eye, a lead line through the eye will cross the outlet.

In an embodiment, the first part has a bottom and side walls, said bottom wall having an elongated shape having two opposite short sides, said first past tapering from one short side to the other and the short side opposite of the short side at the tapered end having an indentation, and said outlet positioned near said short side at the tapered end. In an embodiment the outlet will comprise a spout bonded to the polymer sealing film, in a further embodiment said spout comprising a sealing cap.

In an embodiment, said first part comprises a translucent, in particular transparent, window extending between the top side and the bottom side (when suspended). The window can in particular extend from the top to the bottom side. In an embodiment, said first part is translucent, in particular transparent, clear. Especially for drip feed, this allows medical personal to easily asses the remaining level of product. In another or further embodiment, the sealing film may comprise a translucent, preferably transparent, window. Again, this window can reach from the top to the bottom.

In an embodiment, the packaging further comprises a separate outside packaging holding at least said first part as a tray. In this way, the packaging is protected during transportation. This allows a thinner material to be used for the packaging. The outside packaging can be reused. When stacking it after use, it requires little space.

In an embodiment, said first part is made from ridged polymer material selected from the group consisting of polyester, for instance PET, for instance in the form of amorphous PET, polypropylene (PP) polystyrene (PS), PAN, and PVC, for resulting in a ridged first part. An advantage of such ridged first part is that it can be stored easily, for instance by free standing on a shelf. Furthermore, the ridged first part can be very puncture-resistant. Another advantage of using a ridged first part si that the packaging can also be used in the same way as a bottle, i.e. its contents can also be poured out and used. Thus, the packaging can be used in two ways.

In an embodiment, said first part is made from polymer material which has a thickness of about 50-200 micron. In an embodiment, the film is made from a polymer film of about 150-160 microns comprising a polyamide layer or a polymer film of about 150-160 micron comprising a polyethylene layer. This particularly applies for a packaging with a contents of about 1000-1500 ml. When using a contents of about 500 ml, the film will in most cases be about 120-150 microns thick. In an embodiment, the film will be a laminate comprising a strength providing polymer film as mentioned, laminated with a film which has a lower melting point, for sealing the film onto the first part. A gas barrier layer may also be provided.

In an embodiment, said first part is made from polymer material selected from the group consisting of polyester, for instance PET, for instance in the form of amorphous PET, polypropylene (PP) polystyrene (PS), PAN, and PVC, applied in such a manner as to result in a soft first part. Thus, some of these polymers are provided with additives like plasticizers. A soft packaging can in some cases empty easier under the force of gravity.

In both the soft first part and the ridged first part, the polymer material can be a laminate of various materials, comprising a layer of the mentioned polymer material. Other layers may comprise a barrier layer, such as a gas-tight or vapour-tight layer. As such, these layers for deep-drawn packagings are known to a person skilled in the art. For this application, sterile production or processing is of importance.

In an embodiment, said polymer film is a laminate comprising a layer of O(riented)-polyamide, O-polyester or O-polypropylene, a gas-tight barrier layer, for instance of EVOH, SiO2 or AlOx on a side which is attached to the first part, i.e. the inside-side, and said sealing film further comprise a layer of O(riented)-PA, O-PP, O-PET, PE or PP on the outside for allowing the outlet to be sealed on the sealing film. In an embodiment, the sealing film has a thickness of about 50-70 microns.

The invention further pertains to a sealing film comprising a layer of O(riented)-polyamide, O-polyester or O-polypropylene, a gas-tight barrier layer, for instance of EVOH, SiO2 or AlOx on one side of said sealing film, and a layer of O(riented)-PA, O-PP, O-PET, PE or PP on the other side. This allows for instance an outlet to be sealed on the sealing film.

In an embodiment invention pertains to the packaging described above, filled with drip feed.

In an embodiment of the method, it further comprises the step of sterilizing the drip feed before filling said product space with it. An advantage of a deep-drawn production is that it can be done in an aseptic environment. This, the filled packaging may not need sterilization after being sealed. In this way, other materials can be used for the packaging which do not need to be able to resist sterilization temperatures for a longer time. These materials can be optimized for puncture-resistance, weight, aseptic properties.

An advantage of the deep-draw first part is that it can provide a large filling opening. In an embodiment, said first part is deep-drawn with a circumferential rim. Said rim can form a flange. When said flange has a flat, planar upper surface, a sealing film can be attached to said flange-surface.

Using deep draw techniques, one furthermore has a large degree of freedom in choosing the shape of the first part. The shape can thus be better adapted to the use.

In an embodiment, said product space is filled using a filling outlet which closes against said circumferential rim. This makes it possible to fill very fast, without splashing and with the formation of foam.

In an embodiment, said first part is filled using air-tight filling. In fact, when combined with using the circumferential rim, a very fast and clear filling can be accomplished.

Another advantage of using deep-drawn packaging for this specific application is that a protective atmosphere can be used before, during or after filling. This, it may be easier to maintain sterile conditions. This protective atmosphere can for instance be applied under a reduced pressure.

The invention further pertains to a packaging comprising one or more of the characterising features described in the description and/or shown in the attached drawings, and to a method comprising one or more of the characterising features described in the description and/or shown in the attached drawings.

The various aspects discussed in this patent can be combined in order to provide additional advantages. These aspects may be part of one or more divisional patents.

### DESCRIPTION OF THE DRAWINGS

The invention will be further elucidated referring to an embodiment of a packaging shown in the attached drawings, showing in:

FIG. 1 a perspective view of a soft packaging;

FIG. 2 a perspective view of a tray for the packaging of FIG. 1;

FIG. 3 a perspective view of a ridged packaging;

### DETAILED DESCRIPTION OF EMBODIMENTS

The current packaging as currently under development has two distinct embodiments.

In a first embodiment, the packaging is made from flexible material which gives the actual enclosure of the product little structural support. It is soft or flabby. This packaging may be delivered as such, bundled in for instance a box. This packaging may also have a relatively ridged tray in which the enclosure is placed and which tray may be recycled/reused.

In a second embodiment, the packaging is made from material which is more ridged, and which provides a packaging which may be used as such.

In this detailed description, First the soft packaging will be discussed.

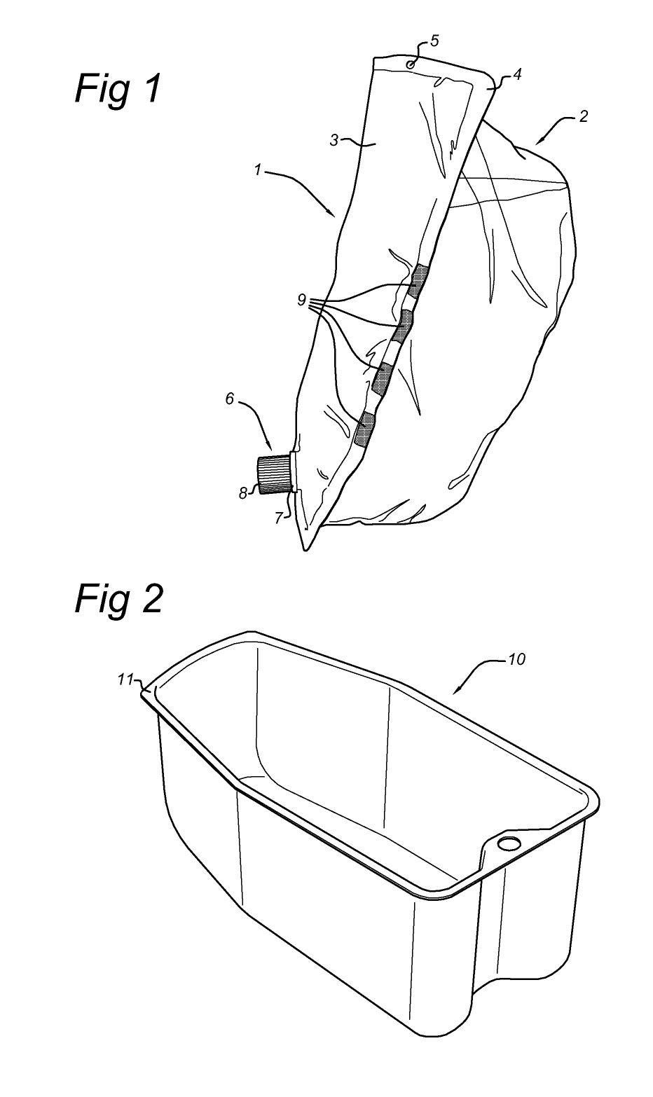

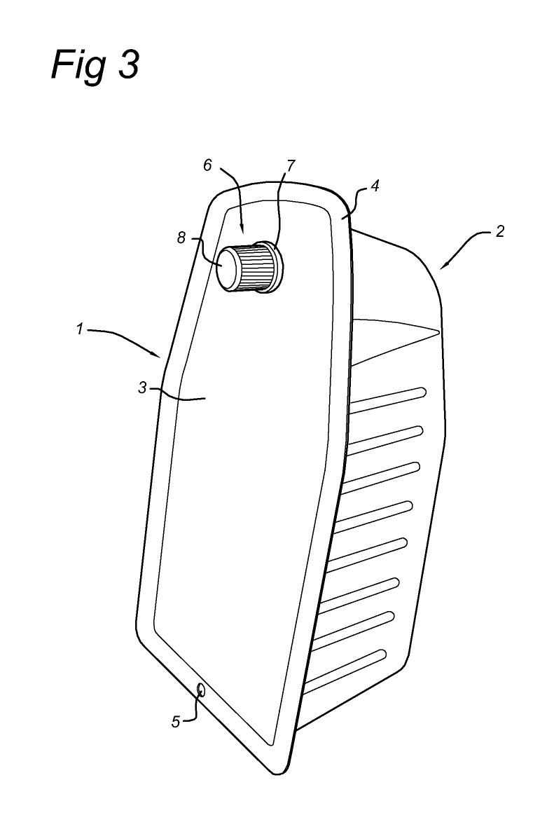

In FIG. 1, a first embodiment of a packaging 1 for drip feed is shown. The packaging has a deep-drawn thermoformed first part 2 which defines a product space. The first part 2 is permanently sealed with a sealing film 3. To that end, the first part 2 has a circumferential flange or rim 4 which has a planar surface onto which the sealing film 3 is permanently sealed. It is not intended that a user is able to remove the sealing film 3 as is usual in case of for instance packaging for cheese. An advantage of the soft packaging is that the amount of waste will be minimal, both in volume and in weight. Furthermore, the type of film used in this type of packaging is very tenacious and puncture-resistant.

Especially for drip feed, where the container for the drip feed product is attached to a stand at a higher level than a patient in order to provide administration largely via gravity, this packaging 2 has an attachment eye 5. This attachment eye 5 is located in the flange or rim 4, which at that location can be broader than the remaining part of the flange 4.

Also provided on or in the sealing film 3, opposite to the attachment eye 5, is an outlet 6. In order to allow the packaging to empty under the force of gravity when the packaging is pendant on the attachment eye 5, the outlet 6 is located as close as possible to the flange 4 and opposite to the attachment eye 5. The outlet should allow attachment of the usual tube which transports the drip-feed to a patient. In this embodiment, the outlet 6 has a spout 7 with outside tread and a cap 8 screwed onto the spout 7. Using a cap, the packaging can be closed when not in use.

The outlet 6 can be attached onto the sealing film 3 before the sealing film 3 is attached onto the first part 2. This can be done in such a way that the sealing film 3 remains intact. In those cases, a cap may be used which can puncture the sealing film 3 before or during its removal from the spout 7. This can provide a maximum of security against contamination.

In another embodiment, the outlet 6 is attached onto the sealing film 3 after sealing film 3 is attached to the first part. In that situation, however, special measures may be needed to prevent puncturing of film 3 and/or spoiling the contents of the packaging 2.

The deep-drawn, thermoformed first part 2 will usually be made from a Polyamide, Polyester or polypropylene film or foil. Suitable films are well-known to a person skilled in the art. The film may be provided with an gas barrier layer like EVOH (ethylene-vinyl alcohol copolymer) covering the product space for preventing the oxygen to come into contact with the interior of the packaging. Again, a person skilled in the art is familiar with these types of barrier layers. The thickness of the films used for the first part 2 usually is about 150 to 160 microns. If an EVOH barrier layer is used, this layer will usually have a thickness of about 25-35 microns.

The sealing film 3 for the “soft packaging” 1 usually is O(riented)-polyamide, O-polyester or O-polypropylene. Again, this film can be provided with a barrier layer of EVOH on a side which is attached to the flange 4, i.e. the inside-side. The sealing film 3 can further comprise a layer of O(riented)-PA, O-PP, O-PET, PE or PP for allowing the outlet to be sealed on the sealing film 3. Usually, the sealing film 3 has a thickness of about 50-70 microns.

FIG. 2 shows an embodiment of a plastic tray 10 which can be used for holding the soft packaging 2 during transport and/or storage. This plastic tray can be re-used, and provides additional protection for in particular the soft packaging 1. It has a rim 11 against which the circumferential flange of the soft packaging 1 can rest.

In the embodiment of the “ridged packaging”, the first part is made from a thicker type of material. Examples of film that can be used are A(morphous)-PET, PAN, Polystyrene, Polypropylene and PVC. These films may be coated with or provided with a laminated film of EVOH as a gas barrier layer. After the first part is formed in the deep-drawing process, the EVOH layer will cover its inside, the product containing space.

An advantage of the ridged packaging is that the packaging is even more puncture-resistant. Furthermore, as this packaging is dimensionally stable, it can easily be placed on a shelf or tabletop.

A further advantage of both the ridged packaging as well as the soft packaging is that the deep-drawn first part 2 can be transparent. This makes it possible to see the remaining contents, in use.

In both the soft packaging as well as the ridged packaging, applying the outlet 6 on the sealing film 3 can be done before the film is attached onto the deep-drawn first part 2 of the packaging, or after the film is attached. Attachment of the outlet 6 can be done using methods which are as such well known to a person skilled in the art. The outlet 6 can be glued or melted on the film. It may also be attached using ultrasonic techniques.

When melting the outlet on the film, a film can be used which is provided with a thin layer of polyethylene (PE) on one or two of its sides. An advantage of applying the outlet, which will often have the form of a spout, on the sealing film before the sealing film is applied on the first part 2, is that it reduced the risk of contaminating the contents.

Filling of both the “soft” packaging as the “ridged” packaging will be the same procedure. Before the sealing film 3 is applied to the first part 2, the first part 2 of packaging 1 will be filled. As the opening for filling thus provided has a very large cross section, it will be possible to fill the product containing space very fast without using high pressure. It may, for instance be possible to use several filling nozzles, but it may also be possible to use one big filling outlet which has a circumferential rim which closes against or within the flange 4 of the first part 2 of the packaging. The product can already be sterilized before or while being administered to the first part 2. The big filling opening which the deep-drawn first part provided reduces the forming of foam during filling.

Filling of the first parts after they were made using the deep-draw process can take place intermittently. In order to prevent splashing of the liquid, it may also be conceived that filling takes place during the time the just-manufactured first parts are being transported to the location where the sealing film is applied. This may require that the filling outlet (or outlets) moves along with the displacing first parts 2 in the production line and filling line.

In use, the packaging is hung close to a person using the attachment eye. In that position, the outlet is below. The cap will be removed from the spout, usually by unscrewing the cap. A tube will be screwed (or snapped) onto the spout and the contents of the packaging will go to the person via the tube. Usually, the packaging will empty under the force of gravity. After use, the empty packaging can be recycled.

It will also be obvious that the above description and drawings are included to illustrate some embodiments of the invention, and not to limit the scope of protection. Starting from this disclosure, many more embodiments will be evident to a skilled person which are within the scope of protection and the essence of this invention and which are obvious combinations of prior art techniques and the disclosure of this patent.

What is claimed is:

1-16. (canceled)

17. A packaging for drip-feed, comprising:
a deep-drawn thermoformed packaging body defining a space sized to receive a product, said packaging body having a flange and an attachment eye located at the flange; and
a polymer film bonded to said flange for covering and sealing the product in said space, said polymer film having an outlet positioned adjacent said flange at an end of said flange opposite said attachment eye when said polymer film is bonded to said flange,
wherein said packaging is shaped such that said outlet is located adjacent said flange to facilitate, when said packaging is suspended from said attachment eye, the product to empty from said packaging under the force of gravity.

18. The packaging of claim 17, wherein said packaging body has a bottom and side walls, said bottom wall having an elongated shape having first and second opposite short sides, said packaging body tapering from said first short side to the second short side and the first short side opposite to the second short side at the tapered end having an indentation, and said outlet positioned adjacent said first short side at the tapered end.

19. The packaging of claim 18, wherein said outlet comprises a spout bonded to the polymer film.

20. The packaging of claim 19, wherein said spout comprises a sealing cap.

21. The packaging of claim 17, wherein said packaging body is translucent.

22. The packaging of claim 17, further comprising a packaging holder defining a space sized to receive said packaging.

23. The packaging of claim 17, wherein said packaging body is made from a polymer material selected from the group consisting of polyester, PET, polypropylene (PP) polystyrene (PS), PAN, amorphous PET, and PVC.

24. The packaging of claim 17, wherein said packaging body is made from a polymer film of about 150-160 microns.

25. The packaging of claim 24, wherein said polymer film comprises one of a polyamide layer and a polyethylene layer.

26. The packaging of claim 17, wherein said polymer film is a laminate film comprising:
an inner first layer comprising a gas-tight barrier layer formed on a side of the polymer film which is attached to said packaging body; and
a second layer composed of one of O(riented)-polyamide, O-polyester and O-polypropylene;
an outer third layer composed of one of O(riented)-PA, O-PP, O-PET, PE and PP which permits said outlet to be sealed on the polymer film.

27. The packaging of claim 26, wherein the polymer film has a thickness of about 50-70 microns.

28. The packaging of claim 17, wherein said first, inner layer comprises one of EVOH, SiO₂ and AlOₓ.

29. A method for making a drip-feed packaging, comprising:
deep-drawing a first polymer film for making a deep-drawn thermoformed packaging body defining a product space;
filling said product space with said drip-feed product;
applying a second polymer film on said packaging body; and then sealing said second polymer film on said packaging body.

30. The method of claim 29, wherein said packaging body is deep-drawn with a circumferential rim.

31. The method of claim 29, further comprising sterilizing the drip feed before filling said product space with drip feed product.

32. The method of claim 31, wherein said packaging body is deep-drawn with a circumferential rim.

33. The method of claim 32, wherein said product space is filled using a filling outlet which closes against said circumferential rim.

34. The method of claim 29, wherein said packaging body is filled using air-tight filling.

35. A drip-feed packaging, comprising:
a packaging body defining a space, said packaging body comprising a circumferential flange having a planar surface and an attachment eye located at the circumferential flange; and
a film sealed to said packaging body at said planar surface to thereby cover and seal the drip-feed in said space,
an outlet provided at the film adjacent said flange at an end thereof opposite said attachment eye when said film is sealed to said packaging body,
wherein said packaging is shaped such that when said packaging is suspended from said attachment eye said outlet permits the drip-feed to empty from said packaging body under the force of gravity.

36. The drip-feed packaging of claim 35, wherein said film comprises a polymer laminate film including:
an inner first layer comprising a gas-tight barrier layer;
a second layer composed of one of O(riented)-polyamide, O-polyester and O-polypropylene;
an outer third layer composed of one of Oriented)-PA, O-PP, O-PET, PE and PP.
